(19) United States
(12) Patent Application Publication
(10) Pub. No.: US 2011/0253710 A1
(43) Pub. Date: Oct. 20, 2011

(54) Container with Fixable Sidewall

(75) Inventors: Jussi Lemola, Espoo (FI); Tom Mellin, Porvoo (FI)

(73) Assignee: DEUTSCHE POST AG, Bonn (DE)

(21) Appl. No.: 13/141,303

(22) PCT Filed: Dec. 17, 2009
(86) PCT No.: PCT/EP2009/009056

§ 371 Date: Jun. 21, 2011

(30) Foreign Application Priority Data
Dec. 29, 2008 (EP) 08022491.8

(51) Int. Cl. B65D 6/28; B23P 11/00

(52) U.S. Cl. 220/4.01; 29/525.01

(57) ABSTRACT

There is provided a container that comprises a pallet and a sidewall. The sidewall has an open base to be placed on top of the pallet defining an internal space for loading at least one object. At least the pallet comprises at least one first connector suitable to removable fix the sidewall on top of the pallet. The sidewall comprises at least one second connector suitable to fit into the at least one first connector. The first connector comprises a locking device suitable to apply a minimum pressure to be overcome with a nose of the second connector arranged parallel to the sidewalls pushing down the locking device during inserting and removal of the second connector to and from the first connector.

### CROSS-REFERENCE TO RELATED APPLICATIONS

Pursuant to 35 U.S.C. §371, this application is the United States National Stage Application of International Patent Application No. PCT/EP2009/009056, filed on Dec. 17, 2009, the contents of which are incorporated by reference as if set forth in their entirety herein, which claims priority to European (EP) Patent Application No. 08 022 491.8, filed Dec. 29, 2008, the contents of which are incorporated by reference as if set forth in their entirety herein.

### BACKGROUND

Document WO2005097611 discloses a container comprising a pallet and a sidewall having an open base and an open top to be placed on top of the pallet in order to prevent workers from lifting the container at the sidewall manually. The sidewall defines an internal space for storage of at least one item (object). The sidewall with open base can be placed on top of a loaded pallet after loading. The sidewall is placed on the pallet with the outer edge of the sidewall being inside the peripheral edge of the top of the pallet. In this way a gap is formed outside the sidewall between sidewall and outer edge of the pallet to prevent the sidewall from falling down the pallet. However, this required gap reduces the available loading area of the pallet. The loaded items (or objects) inside the pallet are placed directly onto the pallet. The risk of slippage of loaded objects during transport depends on the friction coefficient between objects and pallet surface and on the friction coefficient between the objects itself, which does not prevent slippage in case of severe side impacts on pallet and/or sidewall during transport.

### SUMMARY

The subject innovation relates to a container with a sidewall removable fixed attached to a pallet, to a method to attach the sidewall on top of the pallet as well as to the sidewall and the pallet.

The subject innovation may provide a container, where the available loading space is increased and the risk of slippage of loaded objects is reduced.

A container according to the subject innovation may comprise a pallet and a closable sidewall with an open base to be placed on top of the pallet defining an internal space for loading at least one object, where at least the pallet comprises at least one first connection mean suitable to removable attach the sidewall on top of the pallet, preferably the sidewall comprises at least a first side, a second side and a third side. A fixed connection between sidewall and pallet protects the objects loaded to the internal space of the container from side impacts. Non-fixed sidewalls would move in case of side impacts and transfer the side impacts directly to the loaded objects. Additionally, fixed sidewalls cannot slip on and/or from the pallet itself. Therefore, fixed sidewalls can be put directly onto the edge of the pallet, because there is no need for a security gap between the sidewall and the outer edge of the pallet due to eventually slipping sidewalls. The risk of slippage of objects is at least significantly reduced by the fixed sidewall. Subsequently, the top of the pallet can be made of any material not limited to materials with a high friction coefficient in order to minimize slippage of objects as the case would be for non-fixed sidewalls. Preferably the sidewall comprises at least a first, a second and a third side. Such sidewalls for example may be triangular sidewalls with three sides, rectangular sidewalls with four sides, pentagonal sidewalls with five sides, hexagonal sidewalls with six sides, octagonal sidewalls with eight sides etc.

The term “attach” denotes any removable fixed connection. The term “closable” denotes any sidewall, which can be either a single piece sidewall already closed or to be closed via suitable closing means or a sidewall comprising two or more sides which can be attached to each other in order to form a closed sidewalls after closing the closing means. The closable sidewall can be closed before putting the sidewall on top of the pallet or can be closed after putting the sides of the sidewall on top of the pallet. The closing means can be any suitable closing means known by skilled people, e.g., clips, flaps, pins, bolts anchors, clamps, clips, mounting links and hooks to achieve a closed sidewall. Skilled people may choose other closing means within the scope of the subject innovation. The term “removable” denotes the possibility to fix the sidewall before or after loading the items to the pallet and detach the sidewall from the pallet. The advantage of a removable connection between pallet and sidewall is the possibility to replace pallet and/or sidewall separately from each other in case of damage of pallet and/or sidewall saving replacement (maintenance) costs and/or to be able to de-load the pallet from any side. The term “pallet” denotes any kind of pallets, preferably pallets suitable to be moved and/or transported with forklifts. This could be standard pallets, any loadable container base plates and/or base plates/pallets with mounted wheels suitable to be transported with a forklift. The term “on top of the pallet” denotes all kinds of suitable positions of the sidewall to define a loadable volume together with the pallet. The term “on top of the pallet” explicitly includes arrangements, where the sidewall is connected to the side faces of the pallet to define a closed loadable volume with the pallet as the base, for example a sidewall attached to the sides of the pallet in a snug fit manner further fastened to the pallet with first connection means such as claps etc.

In an exemplary embodiment, the first connection means comprises flaps, bolts, pins, poles, posts, anchors, clamps, clips, mounting links, hinges, hooks, a carrier frame adapted to the shape of the sidewall and/or springs or combinations thereof. Depending on the process of how to connect the sidewall to the pallet or vice versa, people skilled in the art may choose suitable combinations and/or the required number of first connection means or other first connection means within the scope of the subject innovation. The above listed first connection means enable a fast connection of pallet and at least one sidewall as well as a fast detaching of the sidewall and pallet saving loading and/or maintenance time and therefore saving costs.

In another exemplary embodiment the pallet further comprises at least one carrier means to carry the at least one first connection means, preferably to carry the at least one removable first connection means. The carrier means could be a pre-mounted frame to insert the sidewall attachable to the frame with suitable first connection means, e.g., flaps, bolts, pins, poles, posts, anchors, clamps, clips, mounting links, hinges, hooks or springs. Another carrier means may be suitable arrangements to carry the first connection means in the pallet surface, preferably in case of first connection means comprising bolts, pins, posts, poles etc. the carrier means comprises recesses, preferably recesses with an open base. In another embodiment the first connection means is a hinge inserted in the carrier mean suitable to be placed from a position essentially horizontal to the top of the pallet to a position essentially vertical to the top of the pallet in order to removable fix the sidewall on top of the pallet, preferably in a snug fit manner to enable fast connection and fast detachment of sidewall and pallet.

In another exemplary embodiment, the first connection means is at least one element of the group comprising bolts, pins, poles and/or posts suitable to be removable inserted in a hole as the carrier means to removable (in a removable manner) fix the sidewall on top of the pallet. Again this combination of first connection means and carrier means to carry the first connection means, enables fast connection and fast detachment of sidewall and pallet, preferably in a snug fit manner. People skilled in the art may consider other carrier means fitting together with other first connection means within the scope of the subject innovation.

In a preferred exemplary embodiment, the pallet comprises an array of carrier means to adapt the position of the at least one first connection means to the shape of the sidewall to be placed on top of the pallet. This array could be adapted to connect all different kinds of sidewalls, preferably the sidewall comprises at least a first, a second and a third side. Such sidewalls for example may be triangular sidewalls with three sides, rectangular sidewalls with four sides, pentagonal sidewalls with five sides, hexagonal sidewalls with six sides, octagonal sidewalls with eight sides etc. and/or different sizes of differently shaped sidewalls.

Different objects to be loaded or different purposes of the loaded objects may require different shapes and/or sizes of the sidewall.

The array of carrier means may be an arrangement of rows and columns of carrier means on and/or within the loadable upper side of the pallet and/or on the sides of the pallet to enable the use of a one pallet for at least a large number of different sidewalls.

In another exemplary embodiment, the sidewall of the container is made of a material selected from the group comprising cardboard, treated cardboard and plastics material or combinations thereof. The use of the above listed materials provide an environmental sustainable solution and will decrease the production costs of sidewalls compared to expensive materials such as metal sidewalls or the like. Wrecked material can be recycled and turned back to functional sidewalls or part of the sidewall (first side, second side, third side etc.). These materials still provide a secure locking structure. It is known to skilled people, that the listed materials are water resistant (for example plastic) or can be made water-resistant in case of cardboard or treated cardboard. Furthermore, these materials are RFID (radio frequency identification) compatible in contrast to metal containers or other containers acting as a Faraday cage, where the RFID signal of objects equipped with RFID tags inside the container cannot be detected. Containers made of the claimed materials are furthermore easy to recognize and globally implementable. Such containers still have a light weight and still a load capacity of 300-400 kg. Furthermore, the material is corrosion free, which avoids expensive maintenance procedures.

To further improve (lower) the weight of the container at least one of the sides of the sidewall may comprise at least one opening in order to reduce the weight of the sidewall. The opening may have any shape. Instead of one opening there may be a regular of irregular pattern of openings of the same or different shapes. In one embodiment, the sidewall has a regular pattern of hexagonally shaped openings covering between 30%-50% of the sidewall area. The reduced weight corresponds to the weight of the sidewall area equal to the total area of openings.

In another exemplary embodiment the sidewall comprises at least one second connection means suitable to fit into the at least one first connection means of the pallet to further improve the fastening of the sidewall to the pallet, which further improves the security of the container and its content during transport, e.g., reduced risk of slippage of loaded objects and improved robustness against side impacts.

Sidewalls with second connection means fitting into the first connection means are able to reduce the required mounting time to close attach, a respectively fix the sidewall on the pallet or to fasten the closed sidewall to the pallet.

In a preferred exemplary embodiment, the second connection means is removable fixed to the sidewall to be replaced and used on another sidewall in case of required replacement of the sidewall in case of damaged sidewalls. The same applies to the replacement of sides of the sidewall, where the sides of the sidewall or some sides of the sidewall are removable connected with closing means to form a sidewall.

In another exemplary embodiment, the first connection means comprise a locking means suitable to apply a minimum pressure to be overcome during inserting and/or removal of the second connection means to/from the first connection means. In one exemplary embodiment, the required minimum pressure to insert the second connection means into the first connection means and vice versa prevents an accidental detachment of the sidewalls from the pallet. As an example a spring can be used to apply an adjustable force to the locking means in order to hold the locking means in the original position.

To insert and/or remove the second connection means into the first connection means, this minimum force has to be overcome. People skilled in the art are able to choose a suitable minimum force in order to provide a locking means with secure locking of the sides of the sidewall to the pallet.

In another exemplary embodiment the sidewall is placed on top of the pallet in a snug fit manner before connecting the at least first connection means to fix the sidewall on the pallet or for the fixation of the sidewall to the first connection means, preferably with the second connection means, which could take place be on top of the pallet or on the sides of the pallet. In this case the open base of the sidewall fits to the size of the pallet, where the open base of the sidewall is slightly larger than the upper loadable side of the pallet to snug fit to the sides of the pallet.

In another exemplary embodiment, the container further comprises a cover to close the top of the container, preferably a cover comprising cover sides being adapted to be put over the sidewall in a snug fit manner to either strengthen the robustness of the container and the sidewall of the container and/or to close the loadable volume in order to further secure the objects against the loss of objects during transport and/or to improve the possibility of stacking the container by enhancing its resilience, especially the resilience of the sidewall. The resilience in order to provide a stackable container may be further enhanced by adding supporting posts to the container, for example with a post present in each corner of the sidewall with a suitable lengths, cross section, material, thickness to place a second container on top of the supporting posts.

The subject innovation further relates to a pallet comprising at least one first connection means suitable to be used in a container as claimed in the present invention. The pallet may be commercialized separately to the container.

The subject innovation further relates to a sidewall comprising at least one second connection means suitable to fit to at least a first connection means of a pallet as claimed in our present invention. The sidewall may be commercialized separately to the container.

The subject innovation further relates to a method to form a container, comprising the steps of:
putting at least a side of the sidewall on top of a pallet comprising at least one first connection means;
connecting the at least one first connection means to the side of the sidewall in order to fix the side of the sidewall to the pallet, preferably connecting the at least one first connection means to a corresponding second connection means of the side of the sidewall fitting into the at least one first connection mean, more preferably by applying a minimum pressure to a locking means arranged in the first connection means, and
closing the sidewall in case of previously non-closed sides placed on top of the pallet.

In case of putting a closed sidewall on top of the pallet, the latter step is not required, because the sidewall is already closed. However, the subject innovation enables both procedures: (a) putting the sides of the sidewall on top of the pallet, connecting the sides to the first connection means and closing the sides of the sidewall afterwards to a closed sidewall and (b) closing the sidewall first and putting the closed sidewall on top of the pallet and connecting the sidewall to the pallet via the first connection means. In a preferred embodiment, the application of a required minimum pressure to insert and/or remove the side to/from the pallet, any accidental detachment is prevented.

In an exemplary embodiment of the method, the method further comprises the step of placing the first connection means to a position adapted to the shape of the sidewall, preferably in a suitable position within an array of carrier means carrying the at least one first connection means before putting the sidewall on top of the pallet.

### BRIEF DESCRIPTION OF THE DRAWING

The above discussed embodiments are only examples. Skilled people may consider modifications of said embodiments within the scope of the subject innovation. More details of the subject innovation are shown in the following figures and the detailed description of embodiments.

FIG. 1 is a diagram of a container according to the subject innovation with a number of different first connection means;

FIG. 2 is a diagram of a pallet according to the subject innovation with hinges as first connection means and corresponding carrier means;

FIG. 3 is a diagram of a pallet according to the subject innovation with poles as first connection means and corresponding carrier means;

FIG. 4 is a diagram of the pallet of FIG. 3 with an array of carrier means to adapt the position of the first connection means to the size/shape of the sidewall;

FIG. 5 is a diagram of a container according to the subject innovation with a frame as the first connection means;

FIG. 6 is a diagram of a sidewall according to the subject innovation with second connection means;

FIG. 7 is a diagram of a side of the sidewall with secure locking means as first and second connection means;

FIG. 8 is a diagram of a container according to the subject innovation with a cover to close the loadable space; and

FIG. 9 is a diagram of a stackable container according to the subject innovation.

### DESCRIPTION OF SPECIFIC EMBODIMENTS

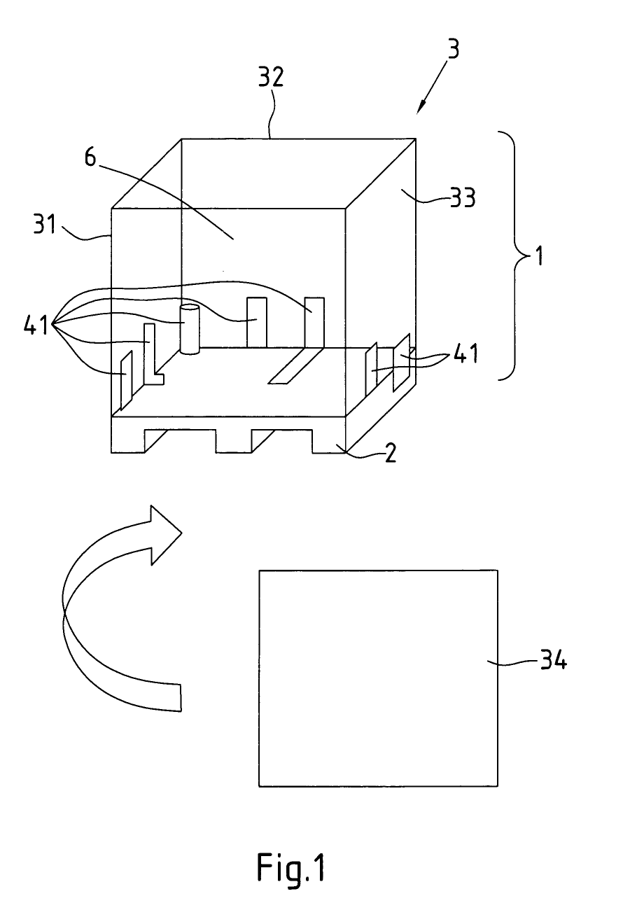

FIG. 1 shows a container 1 according to the subject innovation in a perspective view. The pallet 2 is shown as a black bottom. As an example the sidewall 3 comprises a first side 31, a second side 32, a third side 33 and a fourth side 34 placed on top of the pallet 2. The sidewall 3 may be closed before putting the sidewall 3 on top of the pallet 2 or may be closed after putting the sides 31, 32, 33, 34 on top of the pallet 2. Closing means to close the sidewall 3 can be any suitable closing means known by skilled people, e.g., clips, flaps, pins, bolts anchors, clamps, clips, mounting links and hooks to achieve a closed sidewall 3. The closing means are not shown in this figure. For a better view to the inside of the container 1, the fourth side 34 is shown separately below the container 1. The arrow indicates, that the fourth side 34 is located on the pallet 2 between first side 31 and third side 33 as part of the sidewall 3. The sidewall 3 may comprise openings located in the sides 31, 32, 33, 34 to lower the weight of the sidewall 3. The sidewall 3 is fixed to the pallet 2 via first connection means 41 mounted to the pallet 2. The term “mounted” denotes either a removable mount or a permanent mount to the pallet 2. The type of the first connection means 41 determines the type of connection between pallet and sidewall. First connection means 41 may be flaps, bolts, pins, poles, posts, anchors, clamps, clips, mounting links, hinges, hooks, a carrier frame adapted to the shape of the sidewall and/or springs or combinations thereof. People skilled in the art may choose other first connection means within the scope of the subject innovation. To illustrate the variety of first connection means 41, several first connection means 41 are shown in FIG. 1, for example a post in one of the corners, hinges at the inner side of the sidewall 3 (side facing towards the loadable volume), mounting links connecting the side of the pallet 2 to the side 31, 32, 33, 34 of the sidewall 3. The first connection means 41 may be mounted to the pallet 2 in order to be connected with the inner side 31, 32, 33, 34 of the sidewall 3 or with the outer side of the sidewall 3 (side facing towards the outside of the container). The first connection means 41 may fix the sidewall 3 to the pallet 2 in a snug fit manner or via a direct removable mount, e.g., pins, openings, screws etc. People skilled in the art may consider other suitable measures how the first connection means fix the sidewall to the pallet within the scope of the subject innovation. In alternative embodiments, the first connection means 41 used to fix one side 31, 32, 33, 34 of the sidewall 3 could be different to the first connection means 41 used to fix another side 31, 32, 33, 34 of the sidewall 3 to the pallet 2.

The fourth side 34 in FIG. 1 might be attachable and detachable from the first side 31 and second side 33 in order to open the container 1 to load the container with objects. If detached, the fourth side 34 may be taken away from the pallet 2 using holders which are not shown in this figure. People skilled in the art may choose suitable holders or other means to attach and remove the fourth side 34 (to open and close the container) from the remaining sidewall 31, 32, 33 and pallet 2 within the scope of the subject innovation.

The size of pallet 2 and sidewall 3 can be customized and may have any desired length, depth and height. However, containers (pallet+sidewall) adapted to available storage spaces in trucks, trailers, trains, ships and air planes are advantageous, because the effective use of the available space to transport objects decreases the transportation costs and time.

In another embodiment the fourth side 34 can be arranged as a door or a double wing door connected to at least the first side 31 via opening means to hold and open the door or the wings of the double wing door. Correspondingly, a second wing of the double wing door is attached to the third side 33 via opening means to hold and open the door. The opening means can be identical for both first and second wings or may be different depending on the desired opening characteristics. People skilled in the art will select the appropriate opening means for the desired opening characteristics. As an example, the wings may be able to be opened to an opening angle of 90° and/or an opening angle of 270°. The minimum opening angle required to be able to load the complete loadable volume directly is 90°. The maximum opening angle is 270°, when the door wing(s) contact the outside surface of the first and/or the third side. The opening means may provide any maximum opening angle between 90° and 270°. In an alternative embodiment with a single wing door as the fourth side 34, the previously discussed features and limitations are valid also. The opening means may enable the door wings turned to the inside surface of the first and/or third side. The first and second wings of the double wing door as the fourth side 34 comprise closing means. The closing means will further secure the loaded objects within the container from getting lost during transport, because a locked door cannot be opened accidentally. People skilled in the art will chose appropriate closing means in order to lock the door safety. In alternative embodiments there are 2, 3 4 or more closing means on each door or door wing.

The square shape of the pallet 2 in the FIGS. 1-8 is only one example of any possible shapes. However, a square shape with adapted sizes may be advantageous for certain available storage spaces in transporting vehicles such as trucks, trailers, trains, ships, air planes etc. The pallet shown in FIG. 1 has no first connection means at the fourth side 34 if arranged as a door or double wing door. In this case first connection means at the fourth side 34 would hamper opening of the door.

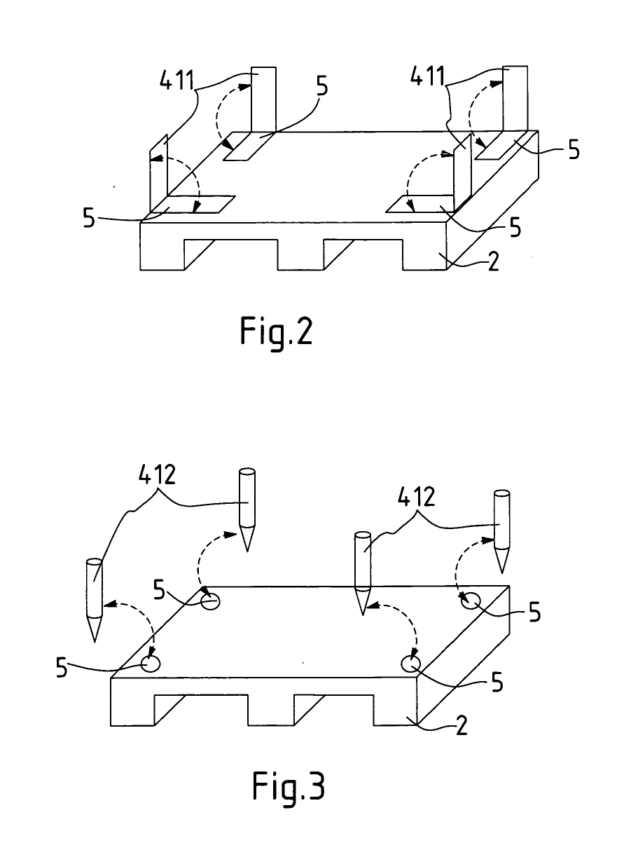

FIG. 2 shows an embodiment of the pallet 2 with first connection means 41 arranged for example as hinges 411 and carrier means 5 to carry the hinges 411. The hinges 411 may be permanently mounted to the carrier means 5 or may be preferably removable mounted to the carrier means 5. The dashed arrows in FIG. 2 indicate, that the hinges a rotatable towards the carrier means 5 in order to build a flat pallet surface if the hinges 411 are rotated towards the pallet. In the upwards position of the hinges, the sidewall (not shown here) can be placed on top of the pallet either with its inner sides touching the hinges or with its outer sides touching the hinges. Depending on shape and size of the sidewall, some first connection means may touch the sidewall on the outer side and some may touch the sidewall on the inner side. The advantage of rotatable hinges is the flat surface of the pallet in case of no sidewall to be mounted. Such a pallet can be used either in combination with a sidewall to forming a container according the subject innovation or separate from a sidewall to carry objects as a loose load pallet.

The same is valid for the pallet 2 and the first connection means 412 arranged as post or poles with corresponding carrier means 5 arranged as holes, where the poles or posts 412 are put into the holes 5 to be mounted to the pallet 2 as shown in FIG. 3. The arrangement of posts or poles 412 in holes 5 could be permanently or preferably removable. In both embodiments shown in FIGS. 2 and 3, the first connection means are arranged in the corners of the pallet. In alternative embodiments the first connection means 41, 411, 412 may be arranged at other positions on the pallet, e.g., apart from the corners of the pallet 2. Shape and material of the first connection means 411, 412 may be any suitable shape or material, for instance cylindrically shaped metal poles or rectangular shaped hinges mounted to rectangular recesses as carrier means within the pallet. The poles/post and hinges 411 and 412 are only two different examples of possible types of the first connection means.

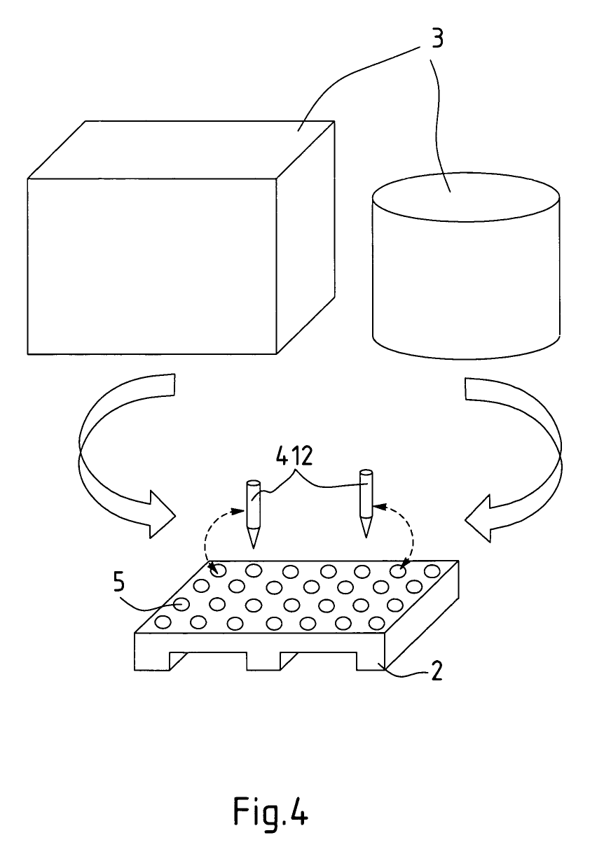

FIG. 4 shows another embodiment of the pallet according to the subject innovation comprising an array of carrier means, where the first connection means can be rut into at any desired position. The position, where the first carrier means (here as one example arranged as poles or posts 412) are to be placed depends on the shape and size of the sidewall 3 to be put on top of the pallet. As an example two different sidewalls 3 are shown in FIG. 4, firstly a rectangular sidewall with an open base fitting to the dimensions of the pallet to be placed on top of the outer edge of the pallet and secondly a round shaped sidewall with an open base of a diameter not extending the outer edge of the pallet. The first connection means 412 have to be put into suitable carrier means to fix the sidewall to the pallet. The shown sidewall geometries in FIG. 4 are only examples. People skilled in the art may consider different sidewall shapes and will select other appropriate positions and/or types of the first connections means within the scope of the subject innovation to fix the sidewall to the pallet. The array of carrier means shown in FIG. 4 as a regular array arranged in rows and columns is only one possible example. Skilled people may consider arrays arranged differently.

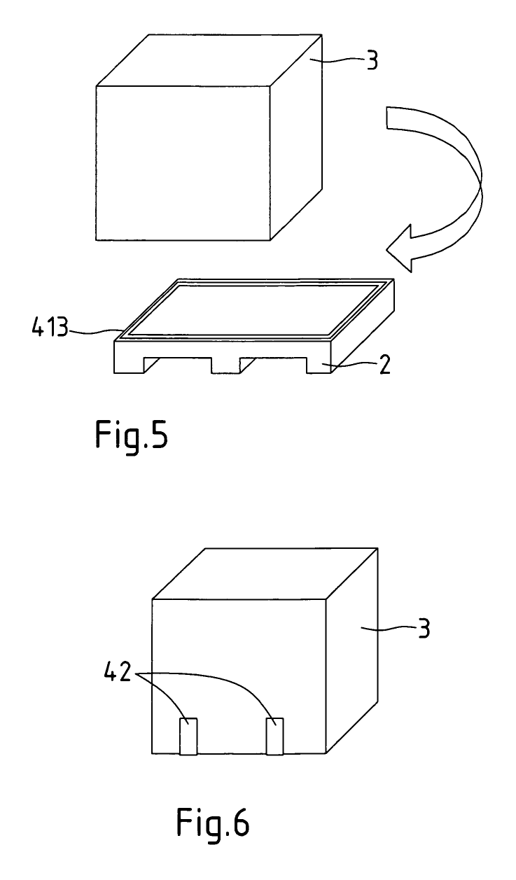

FIG. 5 shows another possible type of the first connection means, a frame 413, where the sidewall 3 can be placed into to be either fixed in a snug fit manner or to be further fixed with additional means as part of the first connection means 413. The frame 413 may be mounted removable on top of the pallet 2 into not shown carrier means. People skilled in the art will choose suitable carrier means to carry a frame 413 within the scope of the subject innovation. There may be different frames 413 with different shapes adapted to different sidewalls 3 to be put on top of the pallet 5. The carrier means may be suitable to carry different frames 413 adapted to different sidewalls 3 with different shapes and/or sizes. Such a pallet can be used in a container according to the subject innovation and alternatively as common pallet after removal of the frame. Suitable carrier means to carry a frame could be holes, wherein adapted pins of the frame 413 are put in to fix the frame to the pallet.

FIG. 6 shows a sidewall 3 according to the subject innovation having second connection means 42 suitable to be connected to corresponding first connection means 41. As an example, a suitable combination of first and second connection means are poles as a first connection means 41 and bushings or jackets as second connection means 42 with suitable diameter to fit over the poles. Another example would be clips as a first connection means 41 and a rail (e.g., metal rail) at the lower side of the sidewall 3, where the clip fits into, as the second connection means 42. Another simple example would be a hook as a first connection means 41 and a hole as a second connection 42 means. People skilled in the art may choose other second connection means fitting to selected first connection means within the scope of the subject innovation. Second connection means 42 fitting to or into the first connection means 41 enable fast fixation of the sidewall 3 to the pallet 2 saving mounting time and/or maintenance time in case of required replacement of the sidewall 3 or sides 31, 32, 33, 34 of the sidewall 3.

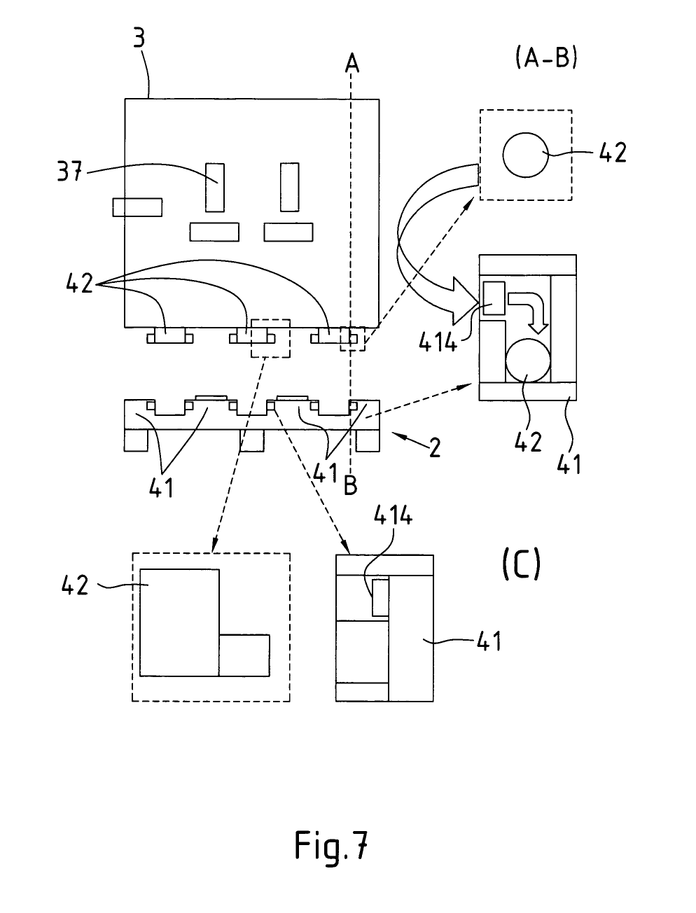

FIG. 7 shows another embodiment of the first and second connection means 41, 42 as secure locking means. The upper left side of FIG. 7 shows a side of the sidewall 3 and the separated pallet 2 in a front view with four first connection means 41 arranged on the pallet 2 on each side of the pallet in order to fix the sides of the sidewall to the pallet with each with corresponding three second connection means fitting into the first connection means 41. The side further comprises collapsing means 37 to support the manual movement of the side towards the pallet during collapsing the container. The collapsing means 37 are only one possible example. People skilled in the art may choose other collapsing means within the scope of the subject innovation. The dashed line A-B denotes the plane of the zoomed side view as shown in the upper right part of FIG. 7 denotes as (A-B). The lower part of FIG. 7 shows the zoomed first and second connections means 41, 42 in the same front view as the pallet and the side of the sidewall above. The dash-dotted arrows indicate the location of the zoomed side and front views in the shown side of the sidewall 3. The locking means 414 enables a secure locking between first and second connection means. To insert the second connection means 42 into the first connection means 41 the locking means 414 have to be pushed down with a certain pressure in order to enter the first connection means with the nose of the second connection means 42 (see small dashed square at the lower part of the side of the sidewall 3) as indicated by the big arrow in the (A-B) part of FIG. 7. After passing the locking means 414, the nose can be further moved downwards the end position (top) within the first connection means 41 in order to be securely locked to the first connection means 41. An accidentally detaching of the side is prevented by the locking means, because it will move back in the originally protruded position after passing the nose of the second connection means 42. Therefore, the nose of the second connection means can only be removed from the first connection means by applying a certain pressure to again push down the locking means in order to pass the nose to the outside of the first connection means 41. The required pressure to push down the locking means 414 may be determined by a spring holding the locking means 414 in the original position. The shape of the locking means 414 as shown in the FIG. 7 is only one example of the possible shapes. People skilled in the art may choose different shapes of the locking means 414 or may choose different measures to establish a certain force to the locking means 414 to hold the locking means in the original position and to define the pressure to be applied in order to insert the second connection means into the first connection means.

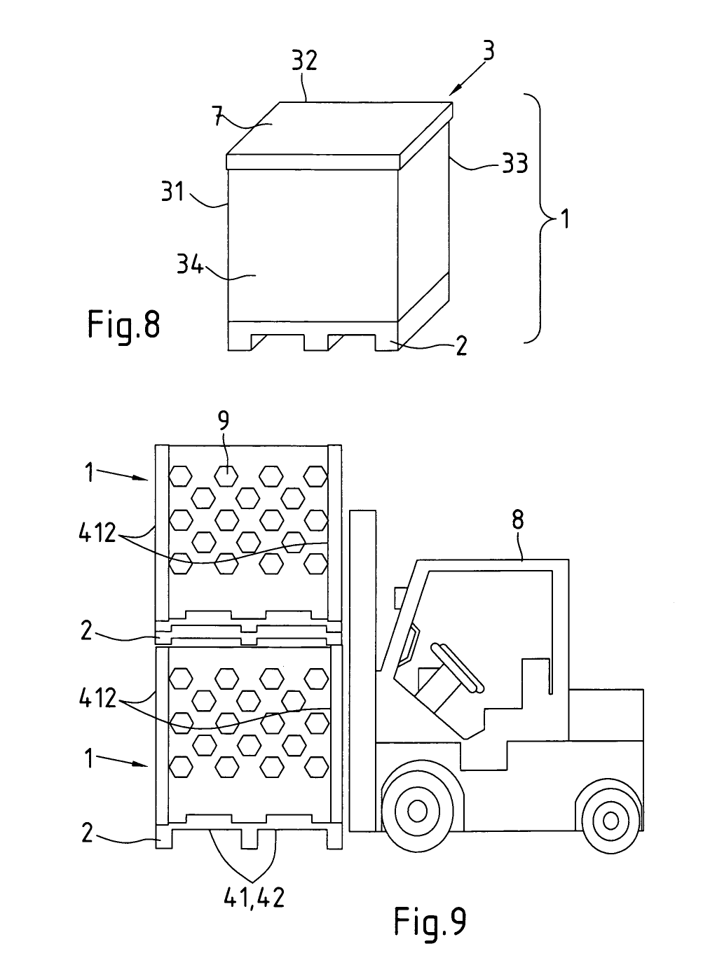

FIG. 8 shows a container 1 comprises an additional cover 7 placed on top of the sidewall 3. The cover is shaped to conform with the loadable volume defined by the sidewall and may comprise a cover top and covers sides, the cover being adapted to be removable and to locate on an outer surface of the sidewall in the manner of a snug fit. The removability of the cover is required in order to maintain the possibility to collapse the container in case of no loaded object in order to save back-transportation space. If the cover is not removed during the loading process, the lay-out of the cover must not affect the opening mechanism of the fourth side, especially in case of doors or double wing doors. For example, suitable covers might have no cover side at the fourth side of the container, or a smaller cover side not blocking the opening of the door.

FIG. 9 shows two stacked containers 1, where the second container is stacked on top of the first container with a forklift 8. The pallet 2 as part of the container 1 enables handling of the containers by forklifts 8, which saves time and therefore costs in case of large and/or heavy weight containers. The stiffness of the sidewall has to be sufficient to stack at least another container on top of the first container. Pallet and loadable volume define a maximum load weight. The stiffness of the sidewall has to be adapted to this maximum load weight in order to be stackable. Thickness of the sidewall and material of the sidewall are two examples of parameters which determine the stiffness of the sidewall within the scope of the subject innovation, if necessary. As an example the container 1 comprises first and second connection means 41, 42 to improve the fixation of the sidewall to the pallet, especially for stackable containers. The resilience of stackable containers can be additionally improved by using poles or posts 412 as additional first connection means, preferably in the corners of the sidewall, with a length at least equal to the height of the sidewall. The second container to be stacked on top of the first container can be placed on top of said poles or posts 412, for example made of metal, fiberglass or hard plastics. In order to provide a stable position of the second container on top of the first container, the poles or posts 412 comprise a flat top. In alternative embodiments, the poles or post 412 might slightly exceed the height of the sidewall not to damage the sidewall in case of stacking.

The openings 9 shown in FIG. 9 shall lower the weight of a sidewall 3. The shown opening 9 are only one possible example to design the sidewall. Sidewalls according to the subject innovation may have different numbers of openings, openings with different shape or no openings for example to keep the inside temperature steady.

In another embodiment, the sidewall can be collapsed onto the upper side of the pallet in order to be transported in a collapsed status to occupy less transportation space in case of no loaded objects. The collapsed sidewall may be collapsed as a single piece sidewall or may be detached into its sides before collapsing the sidewall 3 onto the pallet 2.

The shown embodiments must not be considered as limitation of the invention. The discussed embodiments are only examples of the present invention. People skilled in the art may consider alternative embodiments of the previously disclosed invention still falling into the scope of this invention.

### LIST OF REFERENCES

1 container according to the subject innovation
2 pallet according to the subject innovation
3 sidewall according to the subject innovation
31 first side of the sidewall
32 second side of the sidewall
33 third side of the sidewall
34 fourth side of the sidewall
35 open base
37 collapsing means
41 first connection means
411 hinges as first connection means
412 bolts, pins, poles, posts as first connection means
413 frame as a first connection means
414 locking means
42 second connection means
5 carrier means
6 internal space for loading
7 cover
8 forklift
9 openings

1-16. (canceled)

17. A container, comprising:
a pallet; and
a sidewall with an open base to be placed on top of the pallet defining an internal space for loading at least one object, where at least the pallet comprises at least one first connector suitable to removably fix the sidewall on top of the pallet, wherein the sidewall comprises at least one second connector suitable to fit into the at least one first connector, the first connector comprising a locking device suitable to apply a minimum pressure to be overcome with a nose of the second connector arranged parallel to the sidewalls pushing down the locking device during inserting and removal of the second connector to and from the first connector.

18. The container recited in claim 17, wherein the second connector comprises two oppositely arranged noses, the second connector having a T-like shape established by the two noses.

19. The container recited in claim 17, wherein the first connector comprises an area to insert the second connector into the first connector with the locking device to be passed by the nose of the second connector and another area arranged vertically to the area with the locking device having an end position for the second connector reached by moving the nose downwards after passing the locking device.

20. The container recited in claim 17, wherein the pallet comprises at least one carrier to carry the at least one first connector in a removable manner.

21. The container recited in claim 20, wherein the carrier comprises recesses with an open base.

22. The container recited in claim 20, wherein the pallet comprises an array of carriers to adapt the position of the at least one first connector to the shape of the sidewall to be placed on top of the pallet.

23. The container recited in claim 17, wherein the sidewall is made of a material selected from the group comprising cardboard, treated cardboard and plastics material or combinations thereof.

24. The container recited in claim 17, wherein the second connector is removably fixed to the sidewall.

25. The container recited in claim 17, wherein the sidewall is a closable sidewall comprising two or more sides, which can be attached to each other by suitable closing means in order to form a closed sidewall.

26. The container recited in claim 17, comprising a cover to close the top of the container, the cover comprising cover sides being adapted to be put over the sidewall in a snug fit manner.

27. A pallet, comprising at least one first connector suitable to fit into at least one second connector of a sidewall, the sidewall comprising an open base to be placed on top of the pallet defining an internal space for loading at least one object, the at least one first connector comprising a locking device suitable to apply a minimum pressure to be overcome with a nose of the second connector arranged parallel to the sidewall pushing down the locking device during inserting and removal of the second connector to and from the first connector, the at least one first connector being suitable to removably fix the sidewall on top of the pallet.

28. A sidewall comprising at least one second connector suitable to fit to at least one first connector of a pallet, the sidewall having an open base to be placed on top of the pallet defining an internal space for loading at least one object, where at least the pallet comprises at least one first connector suitable to removably fix the sidewall on top of the pallet, wherein the sidewall comprises at least one second connector suitable to fit into the at least one first connector, the first connector comprising a locking device suitable to apply a minimum pressure to be overcome with a nose of the second connector arranged parallel to the sidewalls pushing down the locking device during inserting and removal of the second connector to and from the first connector.

29. A method to form a container, comprising:
putting at least a side of a sidewall on top of a pallet comprising at least one first connector suitable to fit into at least one second connector of the sidewall; and
connecting the at least one first connector to the corresponding second connector of the side of the sidewall by applying a minimum pressure to a locking device arranged in the first connector with a nose of the second connector arranged parallel to the sidewalls pushing down the locking device.

30. The method recited in claim 29, comprising closing the sidewall with a closing device if previously non-closed sides are placed on top of the pallet.

31. The method recited in claim 29, comprising placing the first connector to a position adapted to the shape of the sidewall, in a suitable position within an array of carriers carrying the at least one first connector before putting the sidewall on top of the pallet.
